(19) United States
(12) Patent Application Publication
(10) Pub. No.: US 2005/0273201 A1
(43) Pub. Date: Dec. 8, 2005

(54) METHOD AND SYSTEM FOR DEPLOYMENT OF SENSORS

(76) Inventors: Deborra J. Zukowski, Newtown, CT (US); James R. Norris JR., Danbury, CT (US); Arthur J. Parkos, Southbury, CT (US); John W. Rojas, Norwalk, CT (US)

Correspondence Address: PITNEY BOWES INC.;35 WATERVIEW DRIVE, P.O. BOX 3000, MSC 26-22, SHELTON, CT, 06484-8000, US

(21) Appl. No.: 10/710,295

(22) Filed: Jun. 30, 2004

Related U.S. Application Data
(60) Provisional application No. 60/521,613, filed on Jun. 6, 2004.
(60) Provisional application No. 60/521,747, filed on Jun. 29, 2004.

(51) Int. Cl. G05B 15/00

(52) U.S. Cl. 700/258; 700/59

(57) ABSTRACT

Systems and methods for consistent deployment of sensors for both physical and virtual objects in a context aware environment for responsive environments are described. A method and apparatus that supports user interactions with both virtual and physical objects wherein any type of object can be explicitly instrumented with a sensor, either virtual or physical. User actions are sensed through these sensors and responses can be determined consistently, regardless of whether the object is physical or virtual.

### CROSS REFERENCE TO RELATED APPLICATIONS

This application claims priority under 35 U.S.C. section 119(e) from Provisional Patent Application Ser. No. 60/521,613, filed Jun. 6, 2004, entitled Responsive Environment Sensor Systems With Delayed Activation (Attorney Docket Number F-822), which is incorporated herein by reference in its entirety. This application claims priority under 35 U.S.C. section 119(e) from Provisional Patent Application Ser. No. 60/521,747, filed Jun. 6, 2004, entitled Responsive Environment (Attorney Docket Number F-822a), which is incorporated herein by reference in its entirety.

### BACKGROUND OF INVENTION

The illustrative embodiments described in the present application are useful in systems including those for use in context aware environments and more particularly are useful in systems including those for consistent deployment of sensors for both physical and virtual objects.

The term responsive environment may be used to describe an environment that has computing capability and access to sensing technology data that allows the environment control to consider its current state or context and new events that occur that may change the state or context.

Sensors are used to transform a standard environment into a responsive environment. Sensors typically detect events such as user-initiated actions and report those actions to the environment. The environment, in turn, can then determine how system-controlled functions can be initiated, stopped or modified in support of an action.

In a responsive environment, actions can take place in the physical domain or the virtual digital domain. For example, a person can take a physical action by selecting a document from a pile of documents residing on a tabletop. Similarly, that person could take action by selecting a document from a folder of documents on a virtual desktop workspace.

In traditional responsive environment systems, completely separate mechanisms are used for the physical and virtual interactions. In the physical world, sensors are affixed to the object or to places where the object may be placed. For example, a physical device that is outfitted with a pressure sensor can announce when the device is touched typically by broadcasting a message. Components in the environment can subscribe to these messages using techniques that are well known to practitioners of the art. For example, tuple spaces, publish/subscribe mechanisms and point-2-point connections may be utilized to generate the appropriate response to the touch.

In the virtual world, interactions with objects are mediated through virtual systems such as graphical user interfaces. To select a document, the user would click on the one of interest and then the graphical interface calls a handler to respond to the click. That handler then directly implements appropriate function such as showing the document.

A group has described a system related to responsive environments and context aware computing that attempt to bring the two sensor worlds together. In a project named the Context Toolkit, a group described a system in relation to the Aware Home system in a paper entitled “A Conceptual Framework and a Toolkit for Supporting the Rapid Prototyping of Context-Aware Applications” by Anind K. Dey, Daniel Salber and Gregory D. Abowd as found in the Human-Computer Interaction (HCI) Journal, Volume 16 (2-4), 2001, pp. 97-166. The group extended the graphical user interface metaphor to the physical world. In this world, all physical sensors are wrapped to look like widgets. Components interested in using the sensor do so by instantiating the appropriate widget in a design-time practice. When that something is sensed, the action method associated with that widget is called.

Accordingly, among other things, the prior art does not provide a context-aware environment that can consistently deploy sensors for both physical and virtual objects.

### SUMMARY OF INVENTION

The illustrative embodiments described herein overcome the disadvantages of the prior art by providing a method and system for those for consistent deployment of sensors for both physical and virtual objects in a context aware environment. A method and apparatus that supports user interactions with both virtual and physical objects wherein any type of object can be explicitly instrumented with a sensor, either virtual or physical. User actions are sensed through these sensors and responses can be determined consistently, regardless of whether the object is physical or virtual.

### BRIEF DESCRIPTION OF DRAWINGS

FIG. 1 is a schematic representation of a representative responsive environment according to an illustrative embodiment of the present application.

FIGS. 2 and 3 are a schematic representation of an illustrative responsive environment according to an illustrative embodiment of the present application.

FIG. 4 is a schematic representation of a model database according to an illustrative embodiment of the present application.

FIGS. 5-6 are flowcharts a representative sensor interaction according to an illustrative embodiment of the present application.

FIGS. 7-8 are flowcharts a representative sensor interaction according to an illustrative embodiment of the present application.

FIG. 9 is a flowchart showing a representative sensor interaction according to an illustrative embodiment of the present application.

FIG. 10 is a flowchart showing a representative sensor interaction according to an illustrative embodiment of the present application.

FIGS. 11a and 11b are flowcharts showing a representative sensor interaction according to an illustrative embodiment of the present application.

### DETAILED DESCRIPTION

Illustrative embodiments describing systems and methods for consistent deployment of sensors for both physical and virtual objects in a context aware environment for responsive environments are described.

Several disadvantages of traditional sensor systems have been described. The illustrative embodiments of the present application provide several advantages over prior systems. The embodiments describe responsive environments that are able to sense and respond to interactions with documents and other objects consistently, regardless of whether those objects are virtual or physical. Additionally, the system is able to reconfigure the responsiveness of the environment to those interactions at run time.

The illustrative embodiments described are in sharp contrast to the wrapper functionality described above. For example, rather than using the metaphor from the virtual world, the embodiments described implement the metaphor from the physical world. That is, that there are objects that sense, report what is sensed, and do nothing more. The illustrative system is designed with such a metaphor to be able to be changed while running in order to provide a run-time approach. Additionally, the system provides a common way of associating the sensors to the objects that they are sensing for, regardless of whether those objects are physical or virtual.

The illustrative embodiments described herein enable all three goals mentioned above. First, the system includes a virtual abstraction of a physical sensor. Second, the system includes a consistent set of models for objects that use sensors across both physical and virtual entities. For example, the model for a cabinet drawer, which is a space capable of holding things like documents, is the same as the model for a virtual object space that is also capable of holding things such as virtual documents. Third, the system includes a method and apparatus for sensor deployment that is consistent for both virtual sensors and physical sensors. This deployment apparatus is used to associate sensors with objects (both virtual and physical) that use them. It is referenced at run time so any changes to it will be immediately reflected in the behavior of the system.

In the illustrative embodiments, systems provide an environment where the focus is on a user”s interaction with a document. In this environment, the response to such interactions should be agnostic to whether the document and sensing are virtual or physical. For example, four representative actions are considered. First, a user touches a physical document as sensed by a physical document sensor (physical document and physical sensor). Second, a user touches a token that represents a virtual document as sensed by a physical sensor (virtual document and physical sensor). Third, a user clicks on a document in a document list as sensed by a virtual sensor (virtual document and virtual sensor). Fourth, a user touches a smart wall that is displaying a document list (virtual document and physical sensor). The environment of the system is capable of responding to the following four interactions in the same manner: For all four interactions, the environment is able to determine that the user is actively using the document.

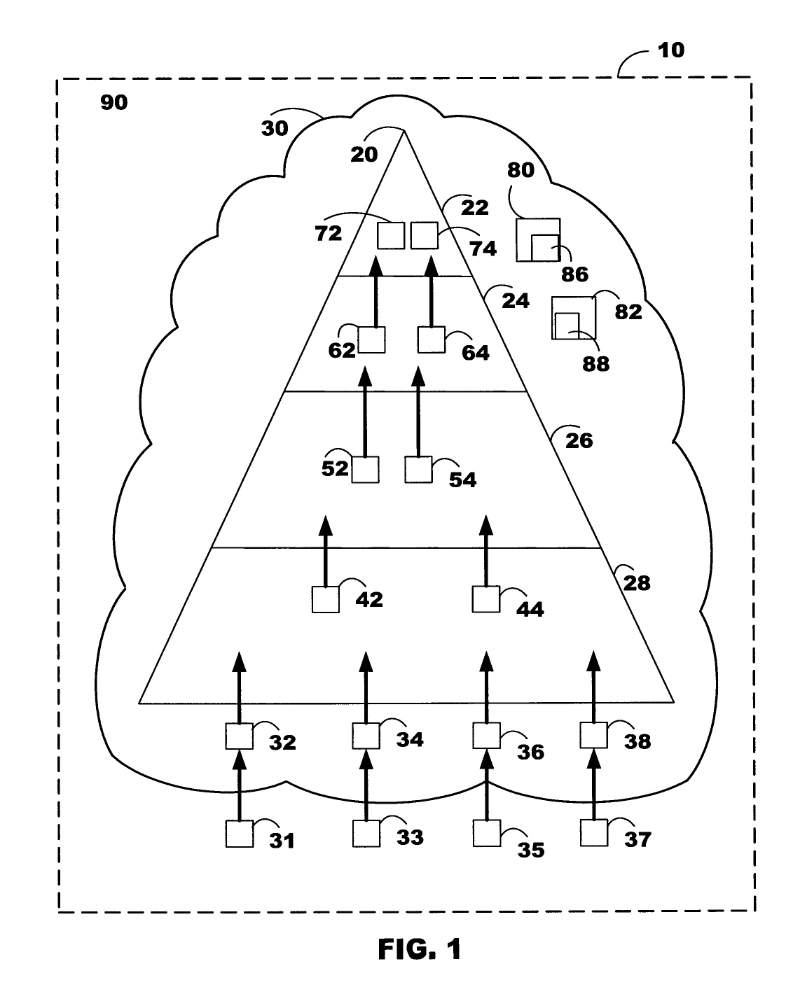

Referring to FIG. 1, an illustrative responsive environment 10 according to an illustrative embodiment of the present application is shown. The representative responsive environment has been implemented in a system known as Atira that includes a context management infrastructure that includes a layered framework of incremental intelligence in the form of a PAUR pyramid 20 that has four layers each including components that have similar overall roles. The components pass messages up to the layer above. However, different components in a particular layer may provide specialized functionality by subscribing to a subset of messages from the layer below.

External stimuli are sensed using physical or logical sensors 31, 33, 35 and 37. The stimuli enter the pyramid 2 through sensor/trigger components 32, 34, 36, 38 that interact directly with the sensors. Those triggers typically only publish into the pyramid rather than subscribe to messages. The lowest layer of the pyramid is the P or Perception layer 28 and it includes several perception components 42, 44. The perception components may subscribe to stimuli events. Similarly, the perception components may publish to the next higher level. The Perceptors are used to filter the types of external stimuli that are used to build the context.

The next level of the pyramid 20 is the A—Awareness layer 26. The awareness layer components 52, 54 are known as Monitors. The monitors manage the state of active entities that are known in the context such as document, application or task entities. The monitors 52, 54 manage the overall state of the environment by updating properties associated with entities. They determine the occurrence of activities such as a person carrying a particular document that may also indicate an additional change in state. They also manage the relationships among the entities.

The next level of the pyramid 20 is the U—Understanding layer 24. The understanding layer components 62, 64 are known as Grokkers. The grokkers determine the types of activities that are underway in the environment. The grokkers determine if changes in the context merit a change in behavior in the room, and if so, determines the type of behavior and initiates it. Grokkers are also utilized to prime applications.

The final level of the pyramid 20 is the R—Response layer 22. The response layer components 72, 74 are known as Responders. The responders semantically drive the environment function and prepare and deliver an announcement that describes the needed behavior. The applications in the environment use the announcements to decide if any function is needed.

The responsive environment 10 includes thin client applications that reside outside of the context infrastructure 30. For example, an interface browser application 80 may be used to view objects in the environment. Additionally, an application launcher client 82 may be used to launch external applications based upon the context contained in the PAUR pyramid 20. A Notification Manager can be a thin client application with an interactive component that manages the user”s attention. For example, the thin clients 80, 82 include actuators 86 and 88 that are part of the thin client systems. The actuators and thin clients may subscribe to announcements of the system and can also include triggers to create internal stimuli such as an application-entered environment.

The illustrative responsive environment system described utilizes a central server computing system comprising one or more DELL® servers having an INTEL® PENTIUM® processor running the WINDOWS® XP operating system. The system is programmed using the JBOSS system and the Java Messaging System (JMS) provides the publish/subscribe messaging system used in the responsive environment.

In an illustrative embodiment, physical sensor 31 is a scanner system that also includes a computer that interfaces with the sensor component 32 using a serial line or TCP/IP interface. The connections among the physical systems that comprise the logical system 90 include wireless and wired connections among physical computers running the appropriate applications, components and frameworks. Sensors 35, 37 are RFID sensors each including a computer that interfaces with the respective sensor components using a serial line. Sensor 33 may comprise well-known sensors such as thermometers, pressure sensors, odor sensors, noise sensors, motion sensors, light sensors, passive infrared sensors and other well-known sensors. Additional well-known communications channels may also be used. In the illustrative embodiment described, the JBOSS JMS message space is running on one server while the MySQL system is run using another server to maintain tables used in the RDF system for model databases. Additionally, the PAUR components such as component 42 are all running on a third server. The thin clients 80, 82 and thin client components 86, 88 are running on separate client machines in communication with the system 90.

The responsive environment described herein is illustrative and other systems may also be used. For example, a querying infrastructure could be used in place of the notification or publish/subscribe system that is described above. Similarly, the messaging service could be provided across systems and even across diverse system architectures using appropriate translators. While INTEL® processor based systems are described using MICROSOFT® WINDOWS systems, other processors and operating systems such as those available from Sun Microsystems may be utilized.

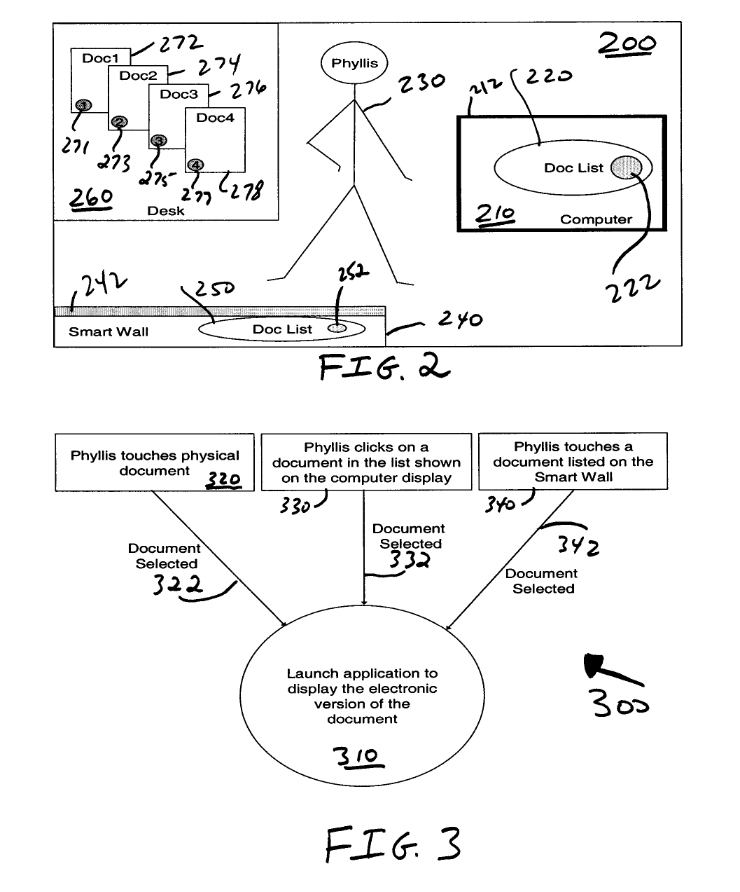

Referring to FIGS. 2 and 3, an illustrative context aware environment 200, 300 according to an illustrative embodiment of the present application is shown.

As physical and virtual sensor information worlds continue to come together, a scenario with the following interactions will become commonplace. As shown in FIG. 2, a person 230, Phyllis is in an office 200 in which many documents are available. Phyllis can begin to work on any one, including those 272, 274, 276, 278 physically arrayed on the desk 260 or any listed either on the document list 220 on computer display 210 or document list 250 on the smart wall 240. The environment and the objects within it, for example, the physical documents, wall, and the document list application, have been instrumented with sensors as shown by the shapes 212, 242, 222, 252, 271, 273, 275, and 277 in the figure. In this illustrative example, when a user 230 selects a document, the environment should launch a document assistant application on the computer that shows the content electronically, as shown in FIG. 3.

If a user touches a physical document in 320, the document selection method 322 causes a method to launch an application to display the electronic version of the document 310. Additionally, if the user selects a document in the computer display list, 330 the document selection method 332 starts the application launcher. Similarly, if the user selects a document listed on the smart wall, 340 the document selection method 342 starts the application launcher.

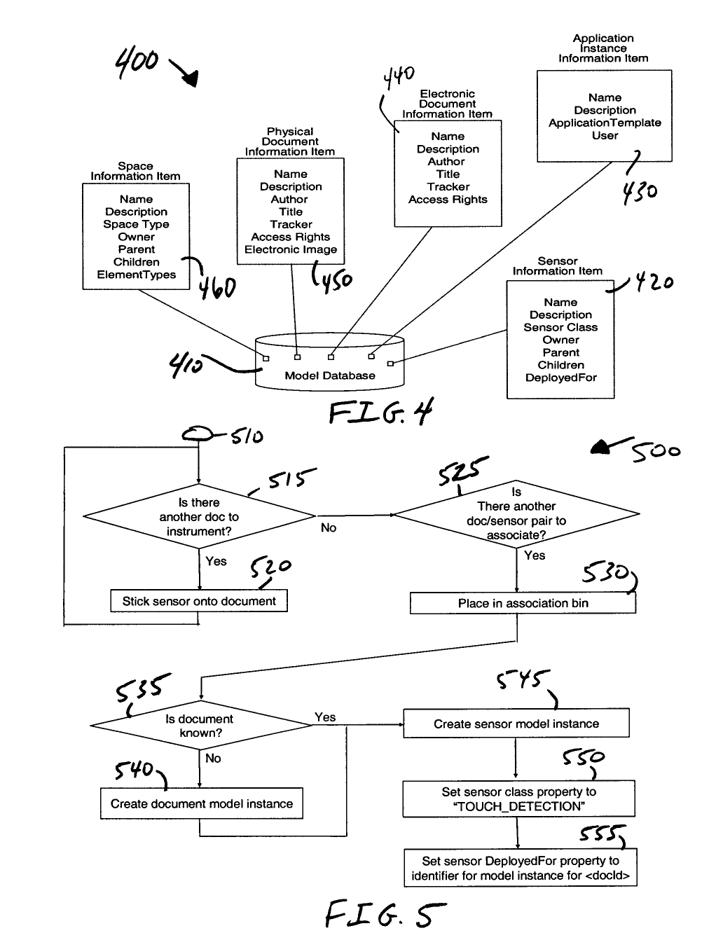

Referring to FIG. 4, a representative model database 410 for a context aware environment 400 is described. The illustrative embodiment of the context aware system describes a method and apparatus for dynamically associating a sensor, either physical or virtual, with either a virtual or physical object. A sensor is affixed to every object that fully participates in a responsive environment. This sensor may be physical, such as a touch or identity sensor, or it may be virtual, such as a software object that models the equivalent physical action. A set of models is instantiated for these sensors. These models may be instantiated prior to the actions, e.g., statically as part of the configuration of the environment or dynamically as the interaction actually occurs.

The representative model database 410 describes example models for important entities that comprise a responsive environment 400. The database 410 includes models for physical entities such as physical documents and spaces (bins and desktops). It also includes models for virtual entities such as applications, virtual spaces, and electronic documents. Sensors are affixed to the objects or associated with the objects by specifying the model instance identifier in the DeployedFor property in the sensor information item 420. As can be appreciated there could be a plurality of model instance identifiers so specified. The sensor model also includes a property to define the class of sensing, e.g., identity, touch, message, and movement detection. It may also contain other properties that more fully describe the sensor, e.g., the owner (for administration) and parent and children (for sets and hierarchical sensors).

The application instance information item 430 includes data associated with applications. The electronic document information item 440 includes data associated with electronic documents. The physical document information item 450 includes data associated with physical documents and includes data such as an access rights list that can be used to mediate physical and virtual interactions with the document. The space information item 460 includes data associated with spaces including information such as parent and children hierarchal information.

Referring to FIGS. 5-11a and 11b, illustrative embodiments of context aware systems according to the present application are shown. In an embodiment, the system includes methods for associating sensors with objects, both statically and dynamically. The embodiment describes a sample interaction of a person touching a document to show how the interaction is supported consistently, regardless of the physicality of the sensor or the document. In each representative case, a simple announcement is generated by a sensor that consists of a message with the sensor identifier and information about the touch. For example, the message includes an identifier and the location of the touch, if the location data is available.

Four illustrative interactions are described. First, a scenario including a Person touching a physical document that has been instrumented with a physical sensor is described. Second, a scenario including a Person touching a virtual document via a token that has been instrumented with a physical sensor is described and in a third scenario, a Person clicking on a document identifier, as listed in a computer application is shown. Fourth, a scenario including a Person touching a smart display (like a surface used for projecting) to select a document as listed by a computer application is shown wherein the smart display having been instrumented with a physical sensor (set).

Referring to FIGS. 5-6, flowcharts of representative sensor interaction according to an illustrative embodiment of the present application are shown. In this example, the method associated with a person touching a physical document is described. In this method, there is a special apparatus to support on-demand associations. The system includes an instrumented space, like a bin, that is capable of determining the document and sensor identifier. The determination may be automatic. For example, both the document and the sensor may include RFID tags that present an identifier. Alternatively, they may be user-driven. For example, the apparatus may include a processor and display that allows the user to input the identifiers. Traditional identifier formats may be used including URI”s, numbers and the like. The system can also be configured to register sensor classes such as by using a set of buttons.

In this embodiment, a sensor is physically attached to a document. The user can create a plurality of document/sensor pairings. The user then places one such pairing into the system. As a result of placing the pairing into the system, an application that can create model instances starts. The application determines if a model for the document already exists by using the document identifier to search through model instances of known physical documents. If no such instance exists, then a new one is created. The method then creates an instance for the sensor, setting the DeployedFor property to the identifier for the document”s model instance. As can be appreciated, the property could also be set to the original document identifier, which could then be used as a search key to find the documents model instance. The sensor class is set to TOUCH DETECTION, as the system has been configured for associating touch-based sensors to documents for the purpose of this discussion.

A method for processing documents 500 is shown in FIG. 5. The process starts in step 510. At step 515, the system determines whether there is another document to instrument. If so, a sensor is placed onto the document in step 520 and the process loops back to step 515. If there are no other documents to instrument, the process proceeds to step 525 and determines whether there is another document/sensor pair to associate. If there is no other pair, the process terminates. If there is, the process proceeds to step 530 and the pair is placed into the association bin.

The process then proceeds to step 535 to determine whether the document is known. If the document is not known, a new document model instance is created in step 540. The process then proceeds to step 545 and a sensor model instance is creates. Thereafter in step 550, the sensor class property is set to TOUCH DETERCTION. In step 555, the DeployedFor property of the sensor is set to the identifier for the model instance associated with the document identifier.

A method for detecting when a user touches a document 600 is shown in FIG. 6. In step in step 610, a user touches a sensor on a document. In step 620, the sensor sends a touch detection message.

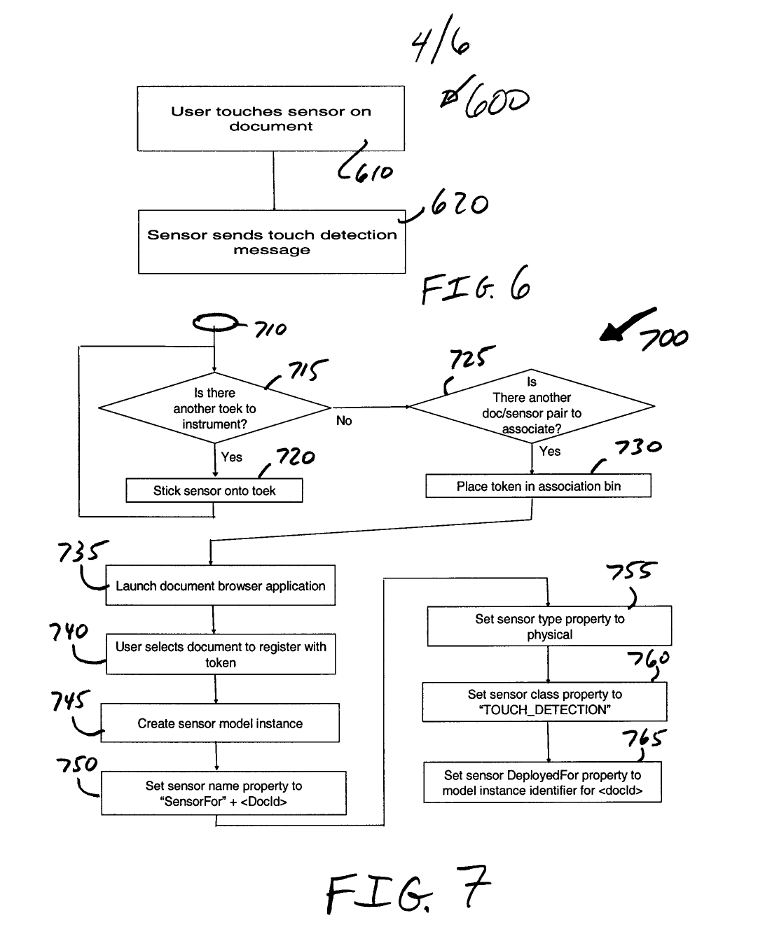

Referring to FIGS. 7-8, flowcharts of representative sensor interaction according to an illustrative embodiment of the present application are shown. In this example, the method is associated with a person touching or interacting with a virtual document using a tangible interface. In this illustrative example, the tangible interface includes a physical token such as a plastic card. However, other tokens may be used.

This system is similar to that described above with reference to FIG. 5. Referring to FIG. 7, an association between the sensor and the virtual document is created. First the user attaches a sensor to the physical token. The user can create a plurality of such instrumented tokens. The user then places one such token into the system. As a result of placing the token into the system, an application is started that first presents the user with a browser to select the desired virtual document, as defined by known document model instances. When the document is chosen, a sensor model instance is created, and the DeployedFor property is set to the identifier for the model instance of the document. As shown above with reference to FIG. 5, the sensor class is also set to TOUCH DETECTION because the apparatus has been configured for associating touch-based sensors to documents.

Referring to FIG. 7, an illustrative method 700 for processing a token is shown. The process begins in step 710 and proceeds to step 715 to determine whether there is another token to process. If so, the process proceeds to step 720 and a sensor is placed on the token. If not, the process proceeds to step 725 to determine whether there is another document/sensor pair to associate. If there isn”t, the process terminates. If there is, the process proceeds to step 730 and the token is placed in the association bin. The process proceeds to step 735 to launch a document browser application. Then in step 740, the user selects a document to register with the token. In step 745, the process creates a sensor model instance. In step 750, the sensor name property is set to SensorFor and the document identifier. In step 755, the sensor type property is set to physical and in step 760, the sensor class property is set to TOUCH DETECTION.

A method 800 for detecting when a user touches a virtual document is shown in FIG. 8. In step in step 810, a user touches a sensor on a document. In step 820, the sensor sends a touch detection message.

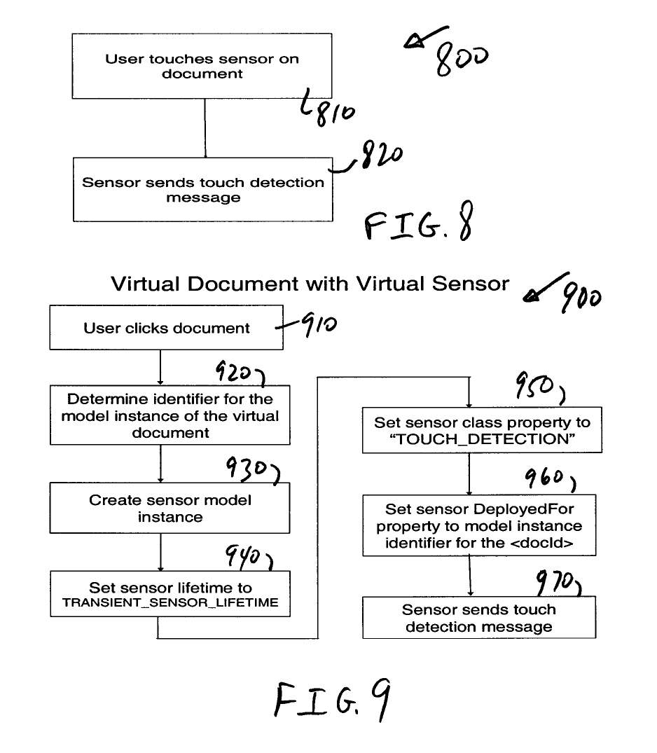

Referring to FIG. 9 a flowchart of a representative sensor interaction according to an illustrative embodiment of the present application is shown. In this example, the method is associated with a person touching or interacting with a virtual document using a virtual interface such as a pointer (mouse, pen) supported by standard window-based user interfaces. In this method, the user selects a document by clicking on a document, as it is displayed in a list. The windowing system includes a handler for these clicks that first determines the identifier for the model instance of the virtual document and then creates an instance for the sensor in the model. This sensor is transient, by nature, so a lifetime property for the sensor is initialized to TRANSIENT SENSOR LIFETIME. The value for this property will be decreased as time progresses. When the lifetime expires, the sensor model instance will be removed. It can be appreciated that the lifetime should be long enough to ensure that all behavior needed in response to the interaction is determined. The handler sets the sensor class property to TOUCH DETECTION and sets the DeployedFor property of the sensor to the model instance identifier associated with the virtual document. It then issues a touch message because the method is executed in response to the actual touch action.

Referring to FIG. 9, an illustrative method 900 for processing a virtual document with a virtual sensor is shown. The process begins in step 910 when a user clicks a document. In step 920, the system determines the identifier for the model instance of the virtual document. In step 930, the process creates a sensor model instance and in step 940, the process sets the sensor lifetime value to TRANSIENT SENSOR LIFETIME. Such a variable can be a defined constant or a variable that is otherwise set. In step 950, the system sets the sensor class property to TOUCH DETECTION and in step 960, the system sets the DeployedFor property to the model instance identifier for the document identifier. The process ends in step 970 when the sensor sends a touch detection message.

Referring to FIG. 10 a flowchart of a representative sensor interaction on a smartboard 1000 according to an illustrative embodiment of the present application is shown. In this example, the method is associated with a person physically touching a projection of a virtual document identifier. For example, a virtual document identifier is displayed in a list rendered on a smart display. The method uses an intermediary system known as the Device Application Manager 1010. The Device Application Manager 1010 intercepts touch messages 1030, and then passes along the knowledge of the touch to applications that are rendered on the display such as the managed application DocList 1020 that displays a list of document identifiers. For example, a whiteboard could be instrumented with a set of sensors that work in concert to determine an x,y coordinate of the touch, as is described in the work done at the MIT Media Lab at the Massachusetts Institute of Technology in Cambridge, Mass.

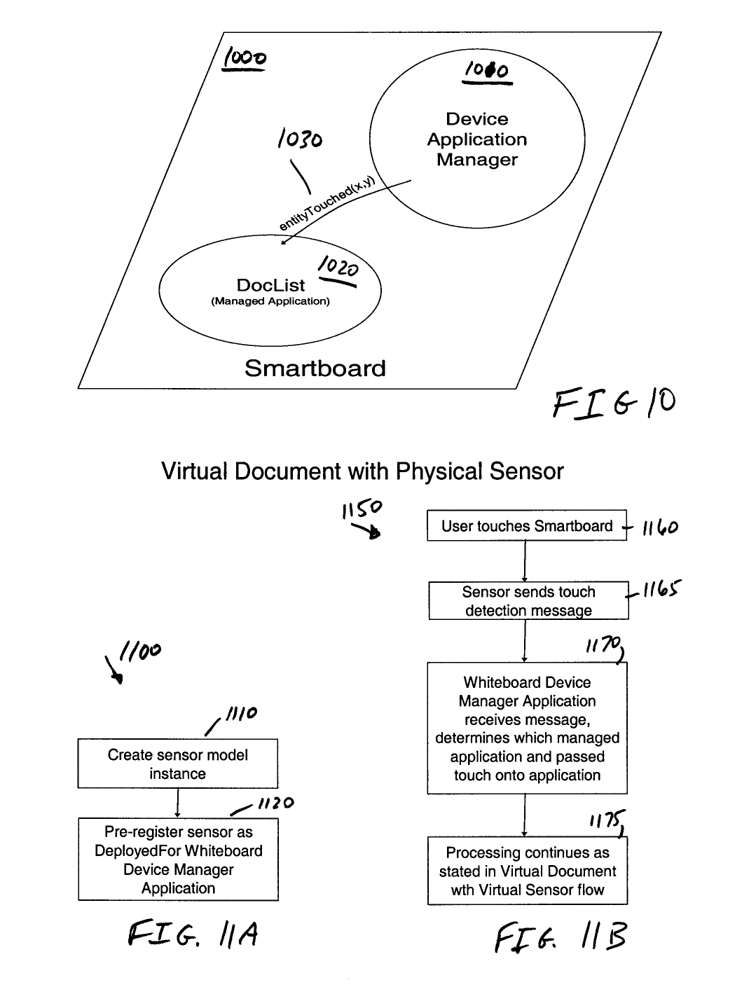

Referring to FIGS. 11a-11b, flowcharts of representative sensor interaction according to an illustrative embodiment of the present application are shown. In this example, the method is associated with processing a virtual document having a physical sensor.

Referring to FIG. 11a, a process 1100 for pre-registering a sensor is shown. In step 1110, the process creates a sensor model instance. In step 1120, the process preregisters the sensor by setting the DeployedFor variable to equal Whiteboard Device Manager Application.

Referring to FIG. 11b, a method 1150 for use when a user touches a document in a list that is projected on the board is shown. The sensors determine the position of the touch and then issue a touch message. The Whiteboard Device Manager application receives the touch message, determines which application was projected in the space that was touched, and then tells that application that a touch has occurred. That application then continues as described by the method shown in FIG. 9.

In step 1160, a user touches the smartboard. In step 1165, the sensor sends a touch detection message. In step 1170, the Whiteboard Device Manager Application receives the message and determines which managed application is appropriate and passes the touch message to the application. Then in step 1175, processing continues as described above in FIG. 9.

All of the illustrative methods described above provide a consistent announcement of the interaction, regardless of how the user interacted with the document. Therefore, any application that embodies responses to the application can be agnostic to the manner in which the interaction occurred. The representative application mentioned included showing an electronic image of the selected document and it is an example of a responsive application. This application listens for any touch message. When a touch message is received, the application uses the sensor identifier to access the sensor”s model instance. It then looks at the DeployedFor property to access the model identifiers of the objects that the sensors are affixed to. These identifiers are used to access model instances. If the models are document models, then the application displays the electronic image, if available. Additionally, the touch message could be enhanced with more information such as the type of object it is attached to for optimizing this type of processing.

The examples described focus on touch interaction, but one of skill in the art could extend the methods and systems described to other types of interactions such as movement and destruction. For the purpose of clarity, simplified scenarios have been illustrated. However, one of skill in the art will be able to practice the invention as described by relaxing the simplification assumptions.

The illustrative embodiments described herein provide a method to determine location, as defined by presence in a space that departs from traditional approaches. In at least one embodiment, the system utilizes a space that can be sparsely instrumented with very inexpensive technology. It uses the notion of concurrent activity to help resolve location ambiguities that may arise from the limitations of such instrumentation.

Co-pending, commonly owned U.S. patent application Ser. No. ______: TBD, filed on even date herewith, is entitled Responsive Environment Sensor Systems With Delayed Activation (attorney docket no. F-822-01) and is incorporated herein by reference in its entirety.

Co-pending, commonly owned U.S. patent application Ser. No. ______: TBD, filed on even date herewith, is entitled Method and System For Determining Location By Implication (attorney docket no. F-871) and is incorporated herein by reference in its entirety.

The present application describes illustrative embodiments of a system and method for determining location by implication. The embodiments are illustrative and not intended to present an exhaustive list of possible configurations. Where alternative elements are described, they are understood to fully describe alternative embodiments without repeating common elements whether or not expressly stated to so relate. Similarly, alternatives described for elements used in more than one embodiment are understood to describe alternative embodiments for each of the described embodiments having that element.

The described embodiments are illustrative and the above description may indicate to those skilled in the art additional ways in which the principles of this invention may be used without departing from the spirit of the invention. Accordingly, the scope of each of the claims is not to be limited by the particular embodiments described.

1. A method for processing a physical token in a responsive environment comprising:
placing a sensor in proximity to the token;
placing the token in an association bin;
launching a document browser application;
obtaining user selection data identifying a document to register with the token; and
creating a sensor model instance.

2. The method of claim 1, further comprising:
setting a sensor name property.

3. The method of claim 3, further comprising:
setting the sensor name property using an identifier associated with the document.

4. The method of claim 1, further comprising:
setting a sensor type property to indicate a physical sensor.

5. The method of claim 1, further comprising:
setting a sensor class property to indicate touch detection.

6. The method of claim 1, wherein,
the sensor is attached to the token.

7. A method for processing a virtual sensor associated with a virtual document in a responsive environment comprising:
obtaining an indication that a user selected a document;
determining the identifier for a model instance of the virtual document;
creating a sensor model instance; and
setting a sensor lifetime value variable associated with the virtual sensor.

8. The method of claim 7, further comprising:
setting a sensor name property.

9. The method of claim 7, further comprising:
setting a sensor type property to indicate a virtual sensor.

10. The method of claim 7, further comprising:
setting a sensor class property to indicate touch detection.

11. A method for processing a physical selection of a projection of a target virtual document identifier associated with a document in a responsive environment comprising:
displaying a plurality of virtual document identifiers including the target virtual document identifier on a smart display;
determining whether the smart display is touched in an area corresponding to the display of the target virtual document identifier; and
if the smart display is touched in an area corresponding to the display of the target virtual document identifier, sending a touch message to a device application manager.

12. The method of claim 11, further comprising:
sending touch message data to the smart display.
